(19) United States
(12) Patent Application Publication
(10) Pub. No.: US 2007/0223545 A1
(43) Pub. Date: Sep. 27, 2007

(54) OPTICAL HEAD AND AN OPTICAL RECORD PLAYBACK EQUIPMENT

(75) Inventors: Yoshio Saito, Tokyo (JP); Hayato Miyashita, Tokyo (JP); Xu Yitai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/681,921

(22) Filed: Mar. 5, 2007

(30) Foreign Application Priority Data
Mar. 17, 2006 (JP) 2006-073857

(51) Int. Cl. H01S 3/04

(52) U.S. Cl. 372/36

(57) ABSTRACT

Optical head 1 has heat sink 6. This heat sink 6 has front overhang section 16 (contact part), the 2nd front drooping sections 17a (contact part) and 17b (contact part), the 1st side drooping section 18, side overhang section 19 (contact part), and the 2nd side drooping sections 20a (contact part) and 20b (contact part) which carry out field contact in laser diodes 4 and 5 and laser holders 12 and 13. Also this heat sink 6 has body part 14 which intervenes between an optical disc and housing 3.

### BACKGROUND OF THE INVENTION

1. Field of the Invention

The present invention relates to the optical record playback equipment which equipped the optical disc with the optical head which performs record or playback of data, and this optical head.

2. Description of the Related Art

In optical record playback equipment, the laser diode is used as a light source.

If generation of heat of a laser diode becomes large, the luminescence quantity of light will fall or a laser diode will break with heat. For this reason, there is a possibility of having a bad influence on the optical beam emitted from a laser diode. Then, the heat generated for the laser diode is made to radiate heat efficiently in the conventional optical head using metal housing with high thermal conductivity.

For this reason, the laser diode was supported in housing by being filled up with a liquefied material which has thermal conductivity equivalent to metal, or adhesives between the above-mentioned housing and a laser diode, and pasting up housing and a laser diode. (For example, refer to Japanese Patent No. 2003-132570.)

Hereafter, this technology is called the 1st conventional example.

Moreover, there are some which are also performing heat dissipation of the heat generated for the laser diode by the main heat sink which makes the heat generated with the laser driver which drives a laser diode radiate heat in the conventional optical head.

When manufacturing this conventional optical head, a laser diode is held to a laser holder and it includes in housing which consists of synthetic resins.

The main heat sink with which a laser driver is installed is attached via the boss who projected and provided in the bottom of housing, and the bottom and the main heat sink of housing are made to estrange by this boss.

In this conventional optical head, a heat transferring member is made to intervene between a laser holder and a main heat sink, and the laser diode is thermally combined with the main heat sink (for example, refer to Japanese Patent No. 2003-157564.).

Hereafter, this art is called the 2nd conventional example. In the latest optical record playback equipment, while the recording rate at the time of recording data on an optical disc accelerates, the laser diode which is a light source is carrying out a high increase in power.

For this reason, it is in the tendency for generation of heat of the laser diode at the time of data logging to become large.

In this case, the temperature of a laser diode may reach to about 70-85 degrees C.

Therefore, it is becoming still more important to make the heat generated with the laser diode radiate heat efficiently.

Therefore, sufficient radiation effect is not acquired only by radiating heat with a metal housing simple substance like the 1st above-mentioned conventional example, or radiating heat with a heat sink simple substance like the 2nd above-mentioned conventional example.

As a result, there is a possibility of having a bad influence on the light beam emitted from a laser diode, for example, luminescence of a laser diode falls or a laser diode breaks with heat.

### SUMMARY OF THE INVENTION

An object of this invention is to solve the above subjects.

This invention is constructed as discribed below in order to solve the aforementioned priblems.

An optical head having housing in which the laser diode which emits the light beam for performing record or playback of data is attached to an optical disc via direct or a laser holder, and a heat sink,

said optical head comprising;

a contact part and a body part are united and said heat sink is formed, said contact part carries out field contact at said laser diode projected from said housing, either of said laser holders, or both,

said body part intervenes between said optical disc and said housing.

Moreover, in the optical head of the present invention, said contact part carries out field contact at said laser diode projected from said housing, either of said laser holders, or both after fixing position adjustment of said laser diode to said housing, or said laser holder.

Furthermore, in the optical head of the present invention, said contact part carries out field contact in two or more parts at said laser diode, either of said laser holders, or both.

Furthermore, in the optical head of the present invention, two or more said laser diode or said two or more laser holders are attached to said housing.

Furthermore, in the optical head of the present invention, two or more through-holes by which the projection which interrupts the wind generated when said optical disc rotates adjoined said body part are drilled.

Furthermore, optical record playback equipment in this invention is characterized by having the optical head of the present invention.

In the optical head of this invention, even if it is when generation of heat of a laser diode is large, heat can be efficiently radiated with a heat sink in the heat generated with the laser diode.

Therefore, the heat dissipation nature of a laser diode is high, and the optical record playback equipment which can perform record or playback of data to an optical disc in the good state can be obtained.

### BRIEF DESCRIPTION OF THE DRAWINGS

FIG. 1 is a perspective view showing the appearance composition of the optical head concerning embodiment of the invention 1.

FIG. 2 is a right side view of the optical head shown in FIG. 1.

FIG. 3 is a perspective view which looked at the appearance composition of the optical head shown in FIG. 1 from angle with another FIG. 1.

FIG. 4 is a perspective view showing the composition of the main section of the optical head concerning embodiment of the invention.

FIG. 5 is a schematic diagram showing the composition of the optical record playback equipment concerning embodiment of the invention 3.

### DETAILED DESCRIPTION OF THE PREFERRED EMBODIMENTS

### Embodiment 1

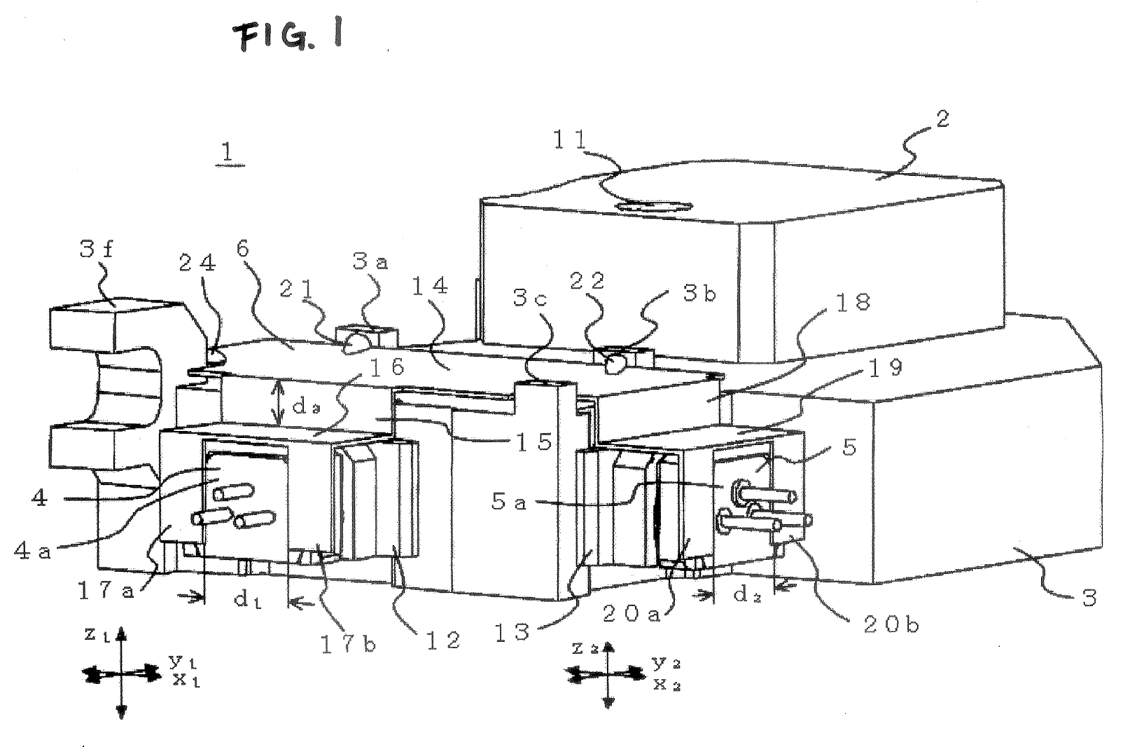

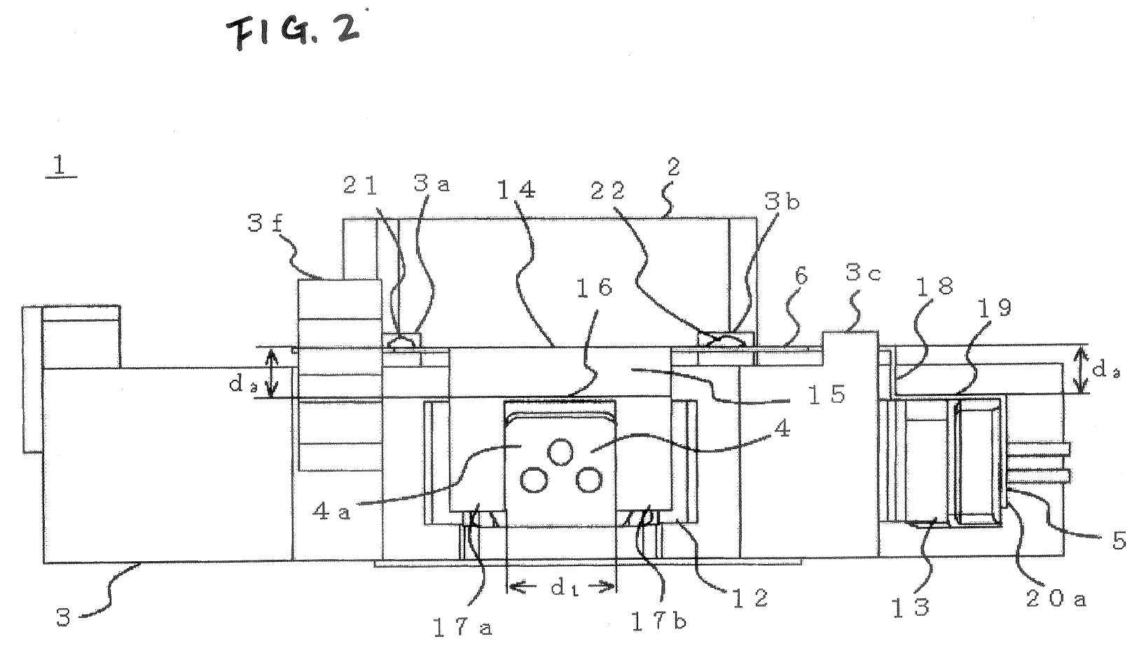

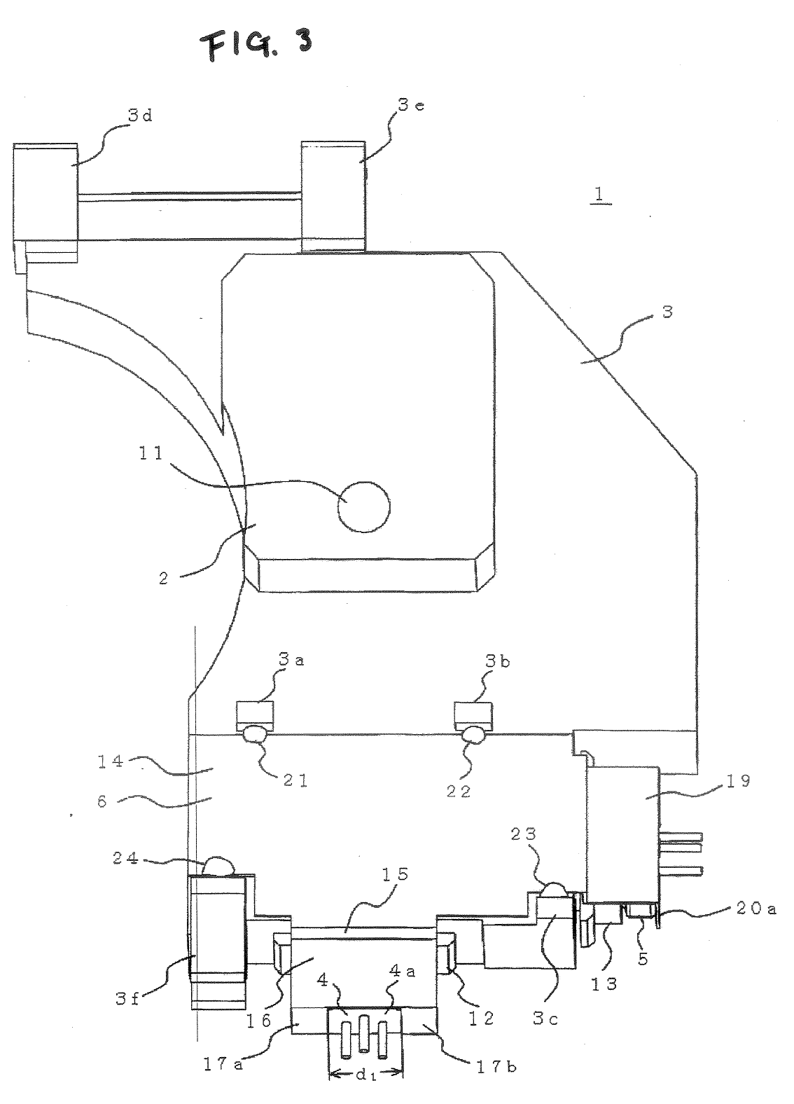

FIG. 1 is a perspective view showing the appearance composition of optical head 1 concerning embodiment of the invention 1. FIG. 2 is a front view of optical head 1 shown in FIG. 1. FIG. 3 is a perspective view which looked at the appearance composition of optical head 1 shown in FIG. 1 from angle with another FIG. 1.

This optical head 1 comprises objective lens driving device 2, housing 3, laser diodes 4 and 5, and heat sink 6.

Objective lens driving device 2 drives objective lens 11 along a focus direction and a tracking direction and also a radial direction, or the tangential direction.

Housing 3 consists of metal, synthetic resins, etc., such as aluminum (aluminum), zinc (Zn), magnesium (Mg), or these alloys, for example.

Objective lens driving device 2 is supported by housing 3 by being attached to the housing 3 upper part.

Adhesive application parts 3a-3c to which adhesives 21-23 for adhering the above-mentioned heat sink 6 to housing 3 are applied are formed in the upper surface of housing 3.

Main-bearings 3d and 3e whose sections are circle shape set a prescribed interval in the back of housing 3, and are formed in it united with housing 3.

Sub-bearings 3f whose section is U type-like are formed in the front of housing 3 united with housing 3. Sub-bearings 3f serve as the adhesive application part to which adhesives 24 for adhering the above-mentioned heat sink 6 to housing 3 are applied.

Laser diode 4 emits the light beam with a wavelength of 650nm used, for example in order to carry out record reproduction of the DVD (Digital Versatile Disk).

Laser diode 4 is inserted in the mounting hole (not shown) formed in the front of housing 3 in the state where it was accommodated in laser holder 12.

After positioning of the laser diode 4 is carried out in the direction (the yl direction shown in FIG. 1) parallel to two directions (the x1 direction and the z1 direction which are shown in FIG. 1) or optical axis direction which intersects perpendicularly with the optical axis direction of the light beam emitted from laser diode 4, it is being fixed by adhesives etc.

Laser holder 12 is formed using die-casting fabrication etc. with metal with zincky (Zn) high thermal conductivity, for example.

Laser diode 5 emits the light beam with a wavelength of 780 nm used, for example in order to carry out record playback of the CD (Compact Disk). Laser diode 5 is inserted in the mounting hole (not shown) formed in the right lateral of housing 3 in the state where it was accommodated in laser holder 13.

After positioning of the laser diode 5 is carried out in the direction (the x2 direction shown in FIG. 1) parallel to two directions (the y2 direction and the z2 direction which are shown in FIG. 1) or optical axis direction which intersects perpendicularly with the optical axis direction of the light beam emitted from laser diode 5, it is being fixed by adhesives etc.

Laser holder 13 is formed using die-casting fabrication etc. with metal with zincky (Zn) high thermal conductivity, for example.

The optical system (not shown) is provided in the core of housing 3. This optical system consists of a beam splitter, a collimate lens, etc. While a beam splitter, a collimate lens, etc. change the optical path of the light beam emitted from the above-mentioned laser diode 4 or 5 and making them emit it from objective lens 11, the light beam which entered from objective lens 11 is completed as the acceptance surface where photodetectors, such as a photo-diode, have been arranged.

Heat sink 6 consists of a plate of metal, such as oxygen free copper (Cu), tough pitch copper (Cu), etc. excellent in electrical conductivity and thermal conductivity.

Here, the thermal conductivity of oxygen free high conductivity copper is 391 [W/m/K]. The thermal conductivity of tough pitch copper is 389.3 [W/m/K]. In heat sink 6, body part 14, the 1st front drooping section 15, front overhang section 16 (contact part), the 2nd front drooping sections 17a (contact part) and 17b (contact part), the 1st side drooping section 18, side overhang section 19 (contact part), and the 2nd side drooping sections 20a (contact part) and 20b (contact part) are united, and are formed.

Body part 14 is the almost same shape as the upper surface shape of the first portion of housing 3.

Connecting the upper limit of the 1st front drooping section 15 to the front of body part 14, the back of the 1st front drooping section 15 has hung approaching the front of housing 3. The end of front overhang section 16 was connected to the soffit of the 1st front drooping section 15, and it is jutted out over the front side of laser holder 12, the undersurface of front overhang section 16 contacting the upper surface of laser holder 12.

The upper limit of the 2nd front drooping sections 17a and 17b was connected to the front both ends of front overhang section 16, respectively, and a part of back of the 2nd front drooping sections 17a and 17b has hung, contacting terminal connection side 4a of laser diode 4 in a field, respectively.

The optical axis direction of the light beam emitted from laser diode 4 and distance d1 of the right end of the 2nd front drooping section 17a and the left end of the 2nd front drooping section 17b cross at right angles.

d1 is slightly set up widely from the maximum adjustable range of positioning of laser diode 4 in the direction (the x1 direction shown in FIG. 1) parallel to the cross direction of laser diode 4.

Connecting the upper limit of the 1st side drooping section 18 to the right lateral of body part 14, the back of the 1st side drooping section 18 has hung approaching the right lateral of housing 3. The end of side overhang section 19 was connected to the soffit of the 1st side drooping section 18, and it is jutted out over the right lateral side, the undersurface of side overhang section 19 contacting the upper surface of laser holder 13 in a field.

The upper limit of the 2nd side drooping sections 20a and 20b was connected to the right lateral both ends of side overhang section 19, respectively, and a part of back of the 2nd side drooping sections 20a and 20b has hung, contacting terminal connection side 5a of laser diode 5 in a field, respectively.

The optical axis direction of the light beam emitted from laser diode 5 and distance d2 of the right end of the 2nd side drooping section 20a and the left end of the 2nd side drooping section 20b cross at right angles.

d2 is slightly set up widely from the maximum adjustable range of positioning of laser diode 5 in the direction (the y2 direction shown in FIG. 1) parallel to the cross direction of laser diode 5.

The distance of the upper limit and soffit in the 1st front drooping section 15 is d3. The distance of the upper limit and soffit in the 1st side drooping section 18 is also d3.

d3 is set up fulfill the conditions shown below.

The optical axis direction of the light beam emitted from laser diode 4 and distance d3 cross at right angles. Here, in a direction (z1 direction shown in FIG. 1) parallel to the height direction of laser diode 4, distance from the upper surface of laser holder 12 when positioning of the laser diode 4 is carried out to the lowest end of the adjustable range in positioning to the upper surface of housing 3 is set to D1 (not shown).

In a direction parellel to the height direction of laser diode 5 (z2 direction shown in FIG. 1), that intersects perpendicularly with the optical axis direction of the light beam emitted from laser diode 5, distance from the upper surface of laser holder 13 when positioning is carried out to the lowest end of the adjustable range in positioning of laser diode 5 to the upper surface of housing 3 is set to D2 (not shown).

d3 is almost equal to the distance of the longer one among these D1 and D2, or is set up become longer than this.

This is based on the reason shown below.

In optical head 1 of this example, two laser diodes 4 and 5 are carried. In this case, even if it is a case where positioning of one laser diode 4 or 5 is carried out to the lowest end of an adjustable range, the undersurface of front overhang section 16 of heat sink 6 can be made to be able to contact the upper surface of laser holder 12, and the undersurface of side overhang section 19 of heat sink 6 can be made to contact the upper surface of laser holder 13.

That is, when shorter than the above-mentioned distance D1 and the above-mentioned distance d3 puts heat sink 6 on housing 3, the undersurface of body part 14 of heat sink 6 contacts the upper surface of housing 3, and the undersurface of front overhang section 16 of heat sink 6 does not contact the upper surface of laser holder 12.

Similarly, when shorter than the above-mentioned distance D2 and the above-mentioned distance d3 puts heat sink 6 on housing 3, the undersurface of body part 14 of heat sink 6 contacts the upper surface of housing 3, and the undersurface of side overhang section 19 of heat sink 6 does not contact the upper surface of laser holder 13.

On the other hand, when d3 is larger than D1, or when equal to D1, the undersurface of front overhang section 16 of heat sink 6 contacts the upper surface of laser holder 12, without the undersurface of body part 14 of heat sink 6 contacting the upper surface of housing 3, when heat sink 6 is put on housing 3.

Similarly, when d3 is larger than D2, or when equal to D2, the undersurface of side overhang section 19 of heat sink 6 contacts the upper surface of laser holder 13, without the undersurface of body part 14 of heat sink 6 contacting the upper surface of housing 3, when heat sink 6 is put on housing 3.

In order to raise the adhesion of the undersurface of front overhang section 16 of heat sink 6, and the upper surface of laser holder 12, heat dissipation resin is applied between the undersurface of front overhang section 16 of heat sink 6, and the upper surface of laser holder 12.

In order to raise the adhesion of each back of the 2nd front drooping sections 17a and 17b, and terminal connection side 4a of laser diode 4, heat dissipation resin is applied between each back of the 2nd front drooping sections 17a and 17b, and terminal connection side 4a of laser diode 4.

Similarly, in order to raise the adhesion of the undersurface of side overhang section 19 of heat sink 6, and the upper surface of laser holder 13, heat dissipation resin is applied between the undersurface of side overhang section 19 of heat sink 6, and the upper surface of laser holder 13.

In order to raise the adhesion of each back of the 2nd side drooping sections 20a and 20b, and terminal connection side 5a of laser diode 5, heat dissipation resin is applied between each back of the 2nd side drooping sections 20a and 20b, and terminal connection side 5a of laser diode 5.

The main components of heat dissipation resin are thermally conductive resin, such as olefin resin, PPS resin (poly phenylene sulfide), polyamide resin (polyamide), silicon system resin, and an epoxy resin.

Moreover, in heat dissipation resin, the filler (filler) which consists of ceramics, such as metal, such as silver (Ag), aluminium oxide (Al2O3), and aluminium nitride (AlN), carbon fiber, or glass contains.

The heat conductivity of heat dissipation resin is 3 [W/mK], when a principal component is olefin system resin and a filler is aluminium oxide (Al2O3) for example.

If a power source is supplied to the optical record playback equipment in which optical head 1 of the above-mentioned composition was carried and it is worked, the heat generated in laser diode 4 or 5 is transmitted to laser holder 12 stuck mutually or 13, heat dissipation resin (not shown), and heat sink 6 one by one, and, finally is diffused to the atmosphere. In this case, when an optical disc (not shown) rotates, atmospheric pressure falls near the disc. A wind occurs inside optical record playback equipment by this toward the rotating optical disc, and this wind collides with the upper surface of heat sink 6.

As a result, the diffusion to the atmosphere of the heat generated in laser diode 4 or 5 is promoted.

When housing 3 consists of metal, such as aluminum (aluminum), zinc (Zn), magnesium (Mg), or these alloys, for example, the heat generated in laser diode 4 or 5 is transmitted to laser holder 12 or 13, and housing 3 one by one. Then, via main-bearings 3d and sub-bearings 3e, 3f, it is transmitted also to a guide shaft (not shown) and heat is radiated.

On the other hand, when housing 3 consists of synthetic resins etc., the heat generated in laser diode 4 or 5 is chiefly transmitted to laser holder 12 or 13, heat dissipation resin, and heat sink 6 one by one, and, finally is diffused to the atmosphere.

Thus, in embodiment of the invention 1, body part 14, the 1st front drooping section 15, front overhang section 16, the 2nd front drooping sections 17a and 17b, the 1st side drooping section 18, side overhang section 19, and the 2nd side drooping sections 20a and 20b are united, and heat sink 6 is formed.

A part of back of the 2nd front drooping sections 17a and 17b contacted terminal connection side 4a of laser diode 4, respectively, and a part of back of the 2nd side drooping sections 20a and 20b is in contact with terminal connection side 5a of laser diode 5, respectively.

d3 is longer than the distance of the longer one of D1 (not shown) and the D2 (not shown), or is set up become equal to the distance of the longer one of D1 and D2.

Therefore, when it is not concerned with positioning of laser diodes 4 and 5 but heat sink 6 is put on housing 3, while the undersurface of front overhang section 16 of heat sink 6 contacts the upper surface of laser holder 12, a part of each back of the 2nd front drooping sections 17a and 17b contacts terminal connection side 4a of laser diode 4, respectively.

Under the present circumstances, the undersurface of body part 14 of heat sink 6 does not contact the upper surface of housing 3. That is, laser diode 4 and laser holder 12 contact in heat sink 6 at two places, terminal connection side 4a of laser diode 4, and the upper surface of laser holder 12.

While the undersurface of side overhang section 19 of heat sink 6 contacts the upper surface of laser holder 13, a part of each back of the 2nd side drooping sections 20a and 20b contacts terminal connection side 5a of laser diode 5, respectively.

That is, laser diode 5 and laser holder 13 also contact at two places of heat sink 6, terminal connection side 5a of laser diode 5, and the upper surface of laser holder 13.

Heat sink 6 is formed in the position where the upper surface is exposed to the wind generated when an optical disc (not shown) rotates.

Thereby, even if it is when laser diode 4 or generation of heat of 5 is large, heat can be efficiently radiated in the heat generated in laser diode 4 or 5.

That is, in this heat sink 6, front overhang section 16, the 2nd front drooping sections 17a and 17b, side overhang section 19, and the 2nd side drooping sections 20a and 20b contact laser diodes 4 and 5 or laser holders 12 and 13. Thereby, front overhang section 16, the 2nd front drooping sections 17a and 17b, side overhang section 19, and the 2nd side drooping sections 20a and 20b function as a contact part for radiating heat.

On the other hand, in the 1st above-mentioned conventional example, heat is radiated with housing in the heat generated with the laser diode. Therefore, it is necessary to use housing which comprised metal with high thermal conductivity. In this case, housing which consists of a synthetic resin with low thermal conductivity etc. will not be able to be used, but a use will be limited.

In the 1st above-mentioned conventional example, a liquefied material or adhesives which has thermal conductivity equivalent to metal is used. However, the thermal conductivity of heat dissipation resin is usually at most about 10 W/m/K to the thermal conductivity of metal being 100-400 W/m/K. Therefore, a liquefied material or adhesives which has thermal conductivity equivalent to metal at present does not exist. Therefore, under the present circumstances, it must be said that a possibility that the art of the 1st above-mentioned conventional example will be realizable is very low.

Furthermore, in the 2nd above-mentioned conventional example, since the main heat sink is formed in the lower part of the optical head, the wind generated by rotation of an optical disc (not shown) cannot be used.

### Embodiment 2

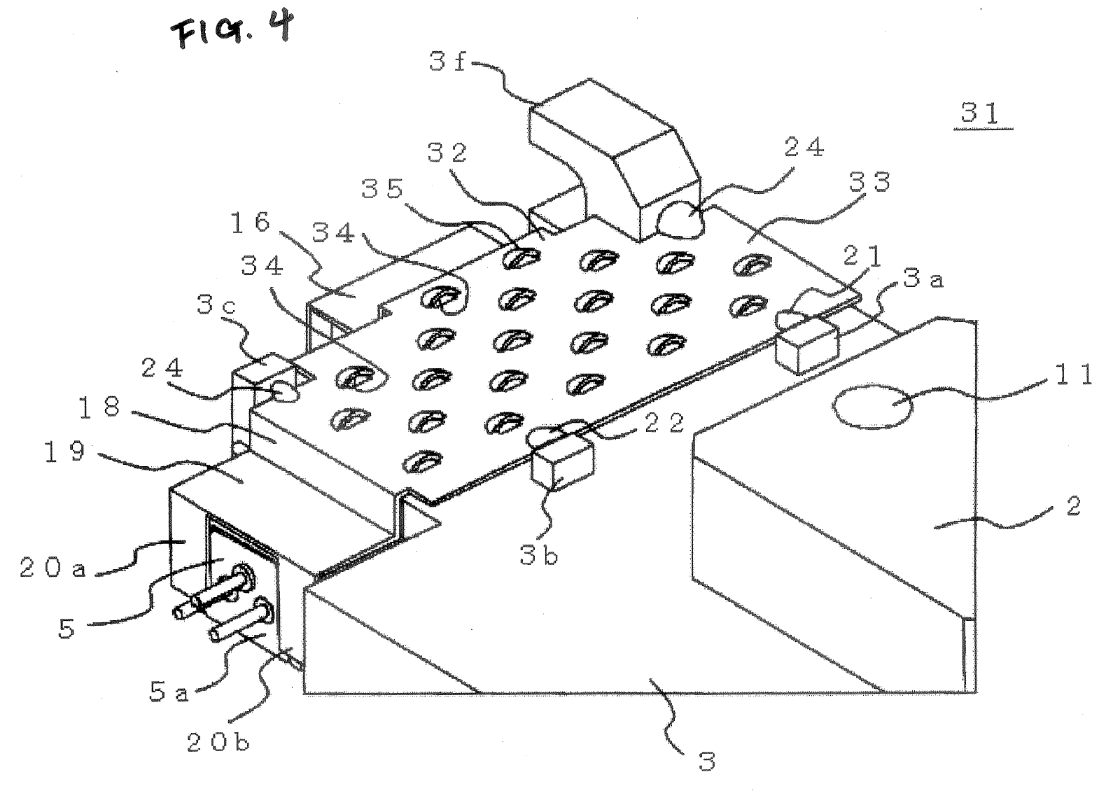

FIG. 4 is a perspective view showing the appearance composition of the important section of optical head 31 concerning embodiment of the invention 2. In FIG. 4, the same numerals are attached to the portion corresponding to each part of FIGS. 1-3, and the explanation is omitted.

In optical head 31 shown in FIG. 4, heat sink 32 is formed instead of heat sink 6 shown in FIGS. 1-3.

Heat sink 32 consists of metal excellent in electrical conductivity and thermal conductivity, such as oxygen free high conductivity copper and tough pitch copper, like the above-mentioned heat sink 6.

Body part 33, the 1st front drooping section 15, front overhang section 16, the 2nd front drooping sections 17a and 17b, the 1st side drooping section 18, side overhang section 19, and the 2nd side drooping sections 20a and 20b are united, and heat sink 32 is formed and constituted. In FIG. 4, it is not illustrated about the 1st front drooping section 15 and the 2nd front drooping sections 17a and 17b.

Two or more circle-shaped through-holes 34 are drilled with the prescribed interval by the upper surface of body part 33. Projection 35 is set up by a part of periphery of each through-hole 34, respectively so that the wind generated when an optical disc (not shown) rotates may be interrupted.

By this composition, the surface area of the whole heat sink 31 is larger than the surface area of the whole heat sink 6 in the embodiment 1 mentioned above.

The formation method of each projection 35 is performed as follows, for example.

That is, it may leave a part of burr generated when drilling each through-hole 34 using a twist drill as corresponding projection 35. When drilling each through-hole 34, the upper surface of body part 33 of heat sink 32 may be cut in the direction most effective for interrupting the above-mentioned wind with a cutting tool, and it may leave some shaving waste produced by the cutting as corresponding projection 35.

The shape of each component in heat sink 32 and the relative dimension between components are the same as the shape of each component in heat sink 6 concerning the embodiment 1 mentioned above, and the relative dimension between components.

The contact part with laser holders 12 and 13, terminal connection side 4a of laser diode 4, and terminal connection side 5a of laser diode 5 and the application part of adhesives are the same as that of these in Embodiment 1.

If a power source is supplied to the optical record playback equipment in which optical head 31 of the above-mentioned composition was carried and it is worked, the heat generated in laser diode 4 or 5 is transmitted to laser holder 12 stuck mutually or 13, heat dissipation resin (not shown), and heat sink 31 one by one, and, finally is diffused to the atmosphere.

In this case, rotation of an optical disc (not shown) will reduce the atmospheric pressure in that neighborhood. A wind occurs inside optical record playback equipment by this toward the rotating optical disc, and a part of this wind hits two or more projections 35 currently formed in the upper surface of heat sink 31. Thereby, the heat transmitted even to two or more projections 35 is radiated by this wind. A part of this wind enters into the undersurface side of heat sink 31 from each through-hole 34, and the heat accumulated in the space formed between the upper surface of housing 3 and the undersurface of heat sink 31 is radiated by this wind.

As a result, the diffusion to the atmosphere of the heat generated in laser diode 4 or 5 is promoted.

When housing 3 consists of metal, such as aluminum (aluminum), zinc (Zn), magnesium (Mg), or these alloys, for example, after the heat generated in laser diode 4 or 5 is transmitted to laser holder 12 or 13, and housing 3 one by one, via main-bearings 3d and 3e and 3f of sub-bearings, it is transmitted also to a guide shaft (not shown) and radiates heat.

On the other hand, when housing 3 consists of synthetic resins etc., the heat generated in laser diode 4 or 5 is chiefly transmitted to laser holder 12 or 13, heat dissipation resin, and heat sink 31 one by one, and, finally is diffused to the atmosphere.

Thus, while two or more through-holes 34 which assume approximate circle shape on the upper surface of body part 33 of heat sink 31 are drilled with the prescribed interval in addition to the composition which explained optical head 31 by the embodiment 1 mentioned above, projection 35 is set up by a part of periphery of each through-hole 34, respectively. Therefore, of course, the effect acquired by the embodiment 1 mentioned above is acquired.

The surface area of the whole heat sink 31 is larger than the surface area of the whole heat sink 6, a wind hits each projection 35, and a wind enters into the undersurface side of heat sink 31 from each through-hole 34. Therefore, as compared with the case of the embodiment 1 mentioned above, the heat generated in laser diode 4 or 5 radiates heat more efficiently.

### Embodiment 3

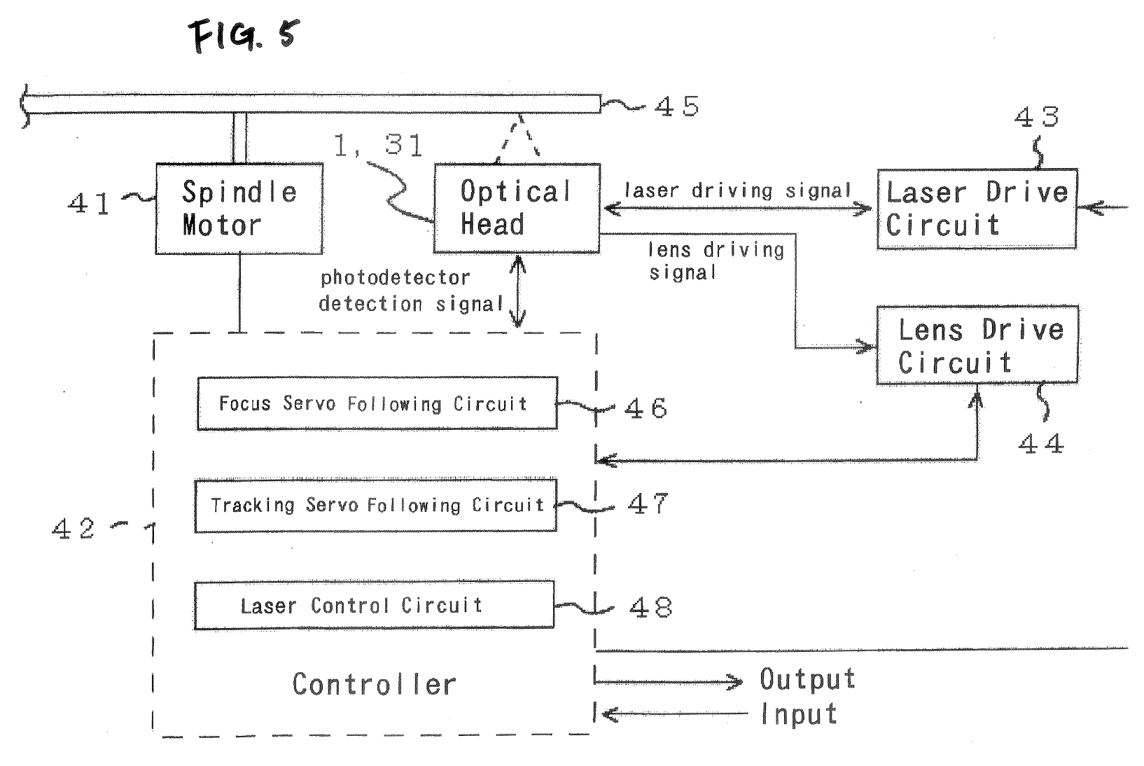

FIG. 5 is a schematic diagram showing the composition of the optical record playback equipment concerning embodiment of the invention 3. This optical record playback equipment comprises mostly optical head 31 concerning optical head 1 concerning the above-mentioned embodiment 1, or the above-mentioned embodiment 2, spindle motor 41, controller 42, laser drive circuit 43, and lens drive circuit 44.

Spindle motor 41 rotates optical disc 45 under control of controller 42.

Controller 42 controls spindle motor 41, laser drive circuit 43, and lens drive circuit 44 based on the photodetector detection signal supplied from optical head 1 or 31.

Laser drive circuit 43 generates the laser driving signal for driving laser diodes 4 and 5 which are the light sources (not shown) which constitute optical head 1 or 31 under control of controller 42, and supplies it to optical head 1 or 31.

Lens drive circuit 44 generates the lens driving signal for controlling focusing and tracking of objective lens 11 (for example, refer to FIG. 1 or 5) which constitute optical head 1 or 31 under control of controller 42, and supplies it to optical head 1 or 31.

Controller 42 has focus servo following circuit 46, tracking servo following circuit 47, and laser control circuit 48.

Based on the photodetector detection signal supplied from optical head 1 or 31, focus servo following circuit 46 generates a focus servo signal, and supplies it to lens drive circuit 44. A focus servo signal adjusts the focus of the light beam emitted to the information storage side of revolving optical disc 45 from optical head 1 or 31.

Based on the photodetector detection signal supplied from optical head 1 or 31, tracking servo following circuit 47 generates a tracking servo signal, and supplies it to lens drive circuit 44. A tracking servo signal makes the beam spot of the light beam emitted from optical head 1 or 31 follow to the signal truck which is carrying out eccentricity of the optical disc 45.

Laser control circuit 48 generates a suitable laser driving signal based on the record condition setting information currently recorded on optical disc 45 extracted from the photodetector detection signal supplied from optical head 1 or 31.

Thus, in embodiment of the invention 3, optical record playback equipment is constituted using optical head 31 concerning optical head 1 concerning the above-mentioned embodiment 1, or the above-mentioned embodiment 2. Therefore, in this optical record playback equipment, the heat generated in laser diode 4 or 5 radiates heat efficiently. Therefore, this optical record playback equipment can perform record or playback of data to an optical disc in the good state, without laser diode 4 or luminescence of 5 falling, or destroying laser diode 4 or 5.

### Embodiment 4

Although the above-mentioned embodiments 1-3 showed the example of the optical record playback equipment in which the optical head in which two laser diodes 4 and 5 as a light source are formed, and one optical head are provided, it is not limited to this.

Also in the optical head which has one light source, or the optical head which has three or more light sources, this invention is applicable. Also in the optical record playback equipment which has two or more optical heads, this invention is applicable.

As mentioned above, although this embodiment has been explained in full detail with reference to a drawing, concrete composition is not restricted to these embodiments, and even if there is change of a design of the range which does not deviate from the gist of this invention etc., it is included in this invention.

For example, although each embodiment mentioned above showed the example which uses heat dissipation resin, it is not limited to this. It may change to heat dissipation resin and a heat dissipation resin sheet, heat dissipation grease, heat dissipation gel or a graphite sheet, etc. may be used.

As resin composition which constitutes a heat dissipation resin sheet, crude rubber, a synthetic-rubber system resin composition, a urethane-resin constituent, a silicon resin composition, or an acrylic resin constituent can be mentioned, for example.

In these heat dissipation resin sheets, the pulverulent body of metal or metallic compounds is blended with each resin as a thermally conductive grant agent. Thereby, thermal conductivity is given to the heat dissipation resin sheet itself.

As such a thermally conductive grant agent, what is used can be used as a general heat-conduction agent. For example, alumimium nitride, boron nitride, silicon carbide, silicon nitride, metallic compounds (an aluminum oxide, magnesium oxide), various metal powders, ceramics, etc. can be used. The addition can be made into about 50 to 800% of the weight to 100% of the weight of resin.

The thermal conductivity of a silicon sheet is 1.0-2.0 W/K, for example, and the thermal conductivity of heat dissipation grease (heat dissipation grease, such as a silicone oil compound) is 1.0-2.0 W/m/K, for example. The thermal conductivity of heat dissipation gel is 4.8-6.5 W/m/K, for example, and although the thermal conductivity of a graphite sheet changes with directions, it is 200-350 W/m/K, for example.

Although the embodiment 1 mentioned above showed the example supported by housing 3 by attaching objective lens driving device 2 to the housing 3 upper part, it is not limited to this. For example, the penetrated part where it is the outer periphery shape and the formed similar figure of the above-mentioned objective lens driving device 2, and the above-mentioned objective lens driving device 2 fits loosely into housing 3 may be formed.

Objective lens driving device 2 is in the state which fitted loosely into the penetrated part of housing 3, and is fixed by adhesives etc. in housing 3 in several each of the upper edge part of a penetrated part, and a lower edge part. Thereby, housing 3 supports the above-mentioned objective lens driving device 2.

In the embodiment 2 mentioned above, although the example in which two or more circle-shaped through-holes 34 are drilled with the prescribed interval was shown, it is not limited to this. For example, shape of through-hole 34 can be made into arbitrary shape, such as the shape of a polygon, and elliptical. It may be random also in the interval which drills through-hole 34.

What is claimed is:

1. An optical head having housing in which the laser diode which emits the light beam for performing record or playback of data is attached to an optical disc via direct or a laser holder, and a heat sink,
said optical head comprising;
a contact part and a body part are united and said heat sink is formed,
said contact part carries out field contact at said laser diode projected from said housing, either of said laser holders, or both,
said body part intervenes between said optical disc and said housing.

2. The optical head according to claim 1,
wherein said contact part carries out field contact at said laser diode projected from said housing, either of said laser holders, or both after fixing position adjustment of said laser diode to said housing, or said laser holder.

3. The optical head according to claim 1,
wherein said contact part carries out field contact in two or more parts at said laser diode, either of said laser holders, or both.

4. The optical head according to claim 2,
wherein said contact part carries out field contact in two or more parts at said laser diode, either of said laser holders, or both.

5. The optical head according to claim 3,
wherein two or more said laser diode or said two or more laser holders are attached to said housing.

6. The optical head according to claim 4,
wherein two or more said laser diode or said two or more laser holders are attached to said housing.

7. An optical head according to claims 1,
wherein two or more through-holes by which the projection which interrupts the wind generated when said optical disc rotates adjoined said body part are drilled.

8. An optical head according to claims 2,
wherein two or more through-holes by which the projection which interrupts the wind generated when said optical disc rotates adjoined said body part are drilled.

9. An optical head according to claims 3,
wherein two or more through-holes by which the projection which interrupts the wind generated when said optical disc rotates adjoined said body part are drilled.

10. An optical head according to claims 4,
wherein two or more through-holes by which the projection which interrupts the wind generated when said optical disc rotates adjoined said body part are drilled.

11. An optical head according to claims 5,
wherein two or more through-holes by which the projection which interrupts the wind generated when said optical disc rotates adjoined said body part are drilled.

12. An optical head according to claims 6,
wherein two or more through-holes by which the projection which interrupts the wind generated when said optical disc rotates adjoined said body part are drilled.

13. An optical record playback equipment characterized by having the optical head according to any one of the claims 1.
